(19) United States
(12) Patent Application Publication
(10) Pub. No.: US 2003/0075657 A1
(43) Pub. Date: Apr. 24, 2003

(54) Scissors lift with combination wedge and lever mechanism

(76) Inventor: Pierre Joubert, Douglasville, GA (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/041,361

(22) Filed: Jan. 8, 2002

Related U.S. Application Data
(60) Provisional application No. 60/330,229, filed on Oct. 18, 2001.

(51) Int. Cl. E04G 3/00; B60P 1/48

(52) U.S. Cl. 248/277.1; 254/9 C

(57) ABSTRACT

A scissors lift with a combination wedge and lever mechanism for switching between wedging action and lever action during lift operation. This device includes a scissors mechanism, a table, a wedging device, a lever device, and an actuator. The scissors mechanism connects to the table such that movement of the scissors mechanism correspondingly moves the table. The wedging device causes a lifting action as the scissors mechanism begins moving between a contracted position and an expanded position. After the lifting action, the lever device translational moves as the scissors mechanism continues moving between the contracted position and the expanded position. Finally, an actuator initiates the lifting device's movement between a contracted positioned and an expanded position by moving in a direction substantially perpendicular to the movement of the scissors mechanism.

### REFERENCE TO RELATED APPLICTIONS

This application claims priority to commonly owned U.S. Provisional Patent Application Serial No. 60/330,229 filed Oct. 19, 2001.

### TECHNICAL FIELD

The present invention relates generally to the field of lifting devices and, more particularly, to a scissors lift with a combination wedge and lever mechanism that switches between wedging action and lever action during the operation of the lift.

### BACKGROUND OF THE INVENTION

Scissors type lifts have been used for generations. They provide the advantage of translating a relatively small closing movement of one end of the scissors mechanism into a much larger opening movement of the mechanism from a contracted position to an expanded position. Typically, the scissors mechanism is configured such that the closing movement of one end of the scissors mechanism results in an opening movement in a substantially perpendicular direction. For the purpose of explanation, consider a scissors lift in which, as one closes one end of the scissors mechanism in a left to right direction, the scissors mechanism expands in a vertical direction. Similarly, as one opens one end of this scissors mechanism in a right to left direction, the scissors mechanism contracts in the vertical direction.

An operational problem arises with this type of scissors mechanism in that the arms of the mechanism move from a generally horizontal position to a generally vertical position as the scissors mechanism moves from the contracted position to the expanded position. Moreover, in a fully contracted position, the scissors arms become horizontal or very nearly horizontal. For this reason, the pivoting moment of a horizontal actuator operating in the horizontal direction on one end of the scissors mechanism approaches zero as the mechanism reaches the fully contracted position. As a result, the force required to lift a load with the scissors mechanism increases precipitously as the mechanism reaches the fully contracted position.

Conversely, in a fully expanded position, the scissors arm is nearly vertical. For this reason, the pivoting moment of a horizontal actuator operating in the vertical direction on an arm of the scissors mechanism approaches zero as the mechanism reaches the fully expanded position. As a result, the force required to lift a load with the scissors mechanism increases precipitously as the mechanism reaches the fully expanded position.

These limitations lead to tradeoff between the range of operation of the scissors mechanism, the load it can carry, and the power requirement of the actuator. Basically, if a horizontal actuator of limited power is used, the vertical lifting capacity diminishes as the scissors mechanism approaches the fully contracted position in which the scissors arms approach a horizontal position. Similarly, if a vertical actuator of limited power is used, the vertical lifting capacity diminishes as the scissors mechanism approaches the fully expanded position in which the scissors arms approach a vertical position. As a result, conventional scissors lifts do not experience a full range motion from a fully expanded to a fully contracted position with efficient utilization of the power of a single actuator throughout this range of motion.

Therefore, there is a need in the art for an improved scissors lift that does not suffer from these limitations. More particularly, there is a need in the art for a scissors lift with a full range motion from a fully expanded to a fully contracted position that efficiently utilizes the power of a single actuator throughout this range of motion.

### SUMMARY OF THE INVENTION

The present invention meets the needs described above in a scissors lift with a combination wedge and lever mechanism that switches between wedging action and lever action during the operation of the lift. This combination mechanism allows the scissors lift to utilize a lifting motion during an initial portion of the motion of the scissors mechanism from the fully contracted position to the fully expanded position, and then switches to translational action applied to one arm of the scissors mechanism during continued motion of the mechanism toward the fully expanded position. This advantageously uses the lifting action when the pivotal moment arm on the end of the arm of the scissors mechanism approaches zero (i.e., as when the arm is in a nearly horizontal position). And then, after a sufficient expansion of the scissors mechanism to provide a sufficient pivotal moment arm, the lift switches to the translational action to complete the expansion of the scissors mechanism. Thus, the present invention provides a scissors lift with a full range motion from a fully expanded to a fully contracted position that efficiently utilizes the power of a single actuator throughout this range of motion.

Generally described, the invention provides a lifting device including a scissors mechanism movable from a contracted position to an expanded position including a wedging device configured to move the scissors mechanism through lifting action applied during an initial portion of the motion of the scissors mechanism from the contracted position to the expanded position.

More specifically, the invention provides a lifting device including a scissors mechanism having a first arm with a pivotally mounted end and a second arm with a traveling end, the scissors mechanism being movable from a contracted position to an expanded position as the traveling end moves towards the pivotally mounted end, and being movable from the expanded position to the contracted position as the traveling end moves away from the pivotally mounted end. The lifting device also includes a wedging device configured to move the scissors mechanism through lifting action applied during an initial portion of the motion of the scissors mechanism from the contracted position to the expanded position. In addition, the lifting device includes a lever device configured to move the scissors mechanism through translation action applied to the traveling end of the second arm during continued movement of the scissors mechanism from the contracted position to the expanded position.

In addition, the lever device may be configured to move the scissors mechanism through translation action applied to the traveling end of the second arm during an initial portion of the movement of the scissors mechanism from the expanded position to the contracted position. Similarly, the wedging device may be configured to move the scissors mechanism during continued movement of the scissors mechanism from the expanded position to the contracted position.

The lifting device may also include an actuator movable from a first position to a second position, and a linkage configured to couple the movement of the actuator to the wedging device during an initial portion of the movement of the actuator from the first position to the second position, and configured to couple the movement of the actuator to the lever device during continued movement of the actuator from the first position to the second position. This linkage may be further configured to couple the movement of the actuator to the lever device during an initial portion of the movement of the actuator from the second position to the first position, and configured to couple the movement of the actuator to the wedging device during continued movement of the actuator from the second position to the first position. In addition, the motion of the actuator between the first position and the second may be substantially perpendicular to the movement of the scissors mechanism between the contracted position to the expanded position.

The lifting device may also include a base configured to support the scissors mechanism, and a table supported by the scissors mechanism and configured to remain substantially parallel to the base as the scissors mechanism moves between the contracted position to the expanded position. The lifting device may also include a safety device configured to discontinue operation of the actuator in response to detecting pressure applied to the base by a structure other than the scissors mechanism. In addition, the base may include a dolly to provide the lift with rolling portability.

In an embodiment of the invention, the wedging device includes a cam surface, a first roller configured to travel along the cam surface, a second roller configured to travel along a lifting surface, and a movable carriage coupled to the actuator. In this configuration, the movable carriage is also coupled to the cam surface, the first roller, or the second roller. As a result, the wedging device imparts the lifting action on the scissors mechanism as the first roller travels along the cam surface and the second roller travels along the lifting surface under the force of the actuator coupled through the movable carriage. In addition, the lifting surface may be a second cam surface, which may be attached to an arm or the scissors mechanism. The lifting device may also include a link, coupled to the movable carriage, that is slidably constrained within a slot in a bracket that is coupled to the traveling end of the second arm of the scissors mechanism.

In another embodiment of the invention, the actuator includes a ball screw and a motor operable to spin the ball screw. In addition, the link includes a ball nut captured on the ball screw and operable to travel along the ball screw in response to spinning of the ball screw. In addition, the actuator is movable from a first position to a second position, and a linkage is configured to couple the movement of the actuator to the wedging device during an initial portion of the movement of the actuator from a first position to a second position, and configured to couple the movement of the actuator to the lever device during continued movement of the actuator from the first position to the second position. The link may be coupled to the movable carriage, and the link may be slidably constrained within a slot in a bracket that is coupled to the traveling end of the second arm of the scissors mechanism.

In view of the foregoing, it will be appreciated that the lifting device of the present invention avoids the drawbacks of conventional scissors lifting and provides a scissors lift with a full range motion from a fully expanded to a fully contracted position that efficiently utilizes the power of a single actuator throughout this range of motion. The specific techniques and structures employed by the invention to improve over the drawbacks of the prior scissors lifting devices and accomplish the advantages described above will become apparent from the following detailed description of the embodiments of the invention and the appended drawings and claims.

### BRIEF DESCRIPTION OF THE DRAWINGS

FIG. 1 is a perspective view of a scissors lifting device in a fully contracted position.

FIG. 2 is a perspective view of the scissors lifting device in a fully expanded position.

FIG. 3 is a perspective view of the scissors lifting device in a fully contracted position with the upper table removed to reveal some lifting components.

FIG. 4 is a perspective view of the scissors lifting device of FIG. 4 with the safety plates removed to more fully reveal additional lifting components.

FIG. 5 is a perspective view of the scissors lifting device of FIG. 4 with additional components removed to more fully reveal additional lifting components.

FIG. 6 is a perspective view of the scissors lifting device of FIG. 5 after a first portion of motion from the contracted position towards the expanded position.

FIG. 7 is a perspective view of the scissors lifting device of FIG. 5 after a second portion of motion from the contracted position towards the expanded position.

FIG. 8 is a perspective view of the scissors lifting device of FIG. 5 after a third portion of motion from the contracted position towards the expanded position.

FIG. 9 is a perspective view of the scissors lifting device of FIG. 5 after a fourth portion of motion from the contracted position towards the expanded position.

FIG. 10 is a perspective view of the scissors lifting device of FIG. 5 after a fifth portion of motion from the contracted position towards the expanded position.

FIG. 11 is a perspective view of the scissors lifting device of FIG. 5 in the fully expanded position.

FIG. 12 is a side view of a wedging device and other lifting components for a scissors lift in a fully contracted position.

FIG. 13 is a side view of a wedging device for a scissors lift after operation of the wedging device to impart a lifting action on the scissors lift.

FIGS. 14A-F are a series of side views of a combination wedging and lever device for a scissors lift progressively showing the expansion of the lift from a fully contracted position to a fully expanded position.

### DETAILED DESCRIPTION OF THE EMBODIMENTS

The present may be embodied in a scissors lift with a combination wedge and lever mechanism for switching between wedging action and lever action during operation of the lift. Using these mechanisms, the lifting device can effectively lift objects of varying size and shape. In a preferred embodiment, this lifting device includes a scissors mechanism, a table, a wedging device, a lever device, and an actuator. Moreover, a base includes a dolly that can support this lifting device.

The scissors mechanism connects to the table such that movement of the scissors mechanism correspondingly moves the table. This table could be composed of aluminum, plastic, a composite, or some other suitable material. The table supports the object being lifted, such as a large screen television or any other object within the lifting capacity of the device. In an alternative embodiment, the table could be replaced by any type of end effector such as a hook, claw, fork, or another suitable device that facilitates lifting the object. In another alternative embodiment, a magnetic end effector can support the object. In this embodiment, the end effector's magnetic nature can hinder the object from sliding.

For easy storage, this lifting device contracts completely. Alternatively, the table in the lifting device can be tilted or substantially flat during storage. As the scissors mechanism moves from a contracted position to an expanded position, the table vertically moves from a lowered position to an extended position. Alternatively, side mounting the lifting device can horizontally move the table. With this orientation, the lifting device can slide a television, for example, into or away from an audience's viewing range. In another alternative embodiment, the lifting device can be mounted above an object to be lifted. For this embodiment, arms that extend downward can lift the desired object.

To facilitate movement, the scissors mechanism includes connected arms that could be composed of aluminum, steel, a composite, or some other suitable material. A first arm has a pivotal end and a second arm has a traveling end. Because these arms are connected, movement of the arms is tracked. That is, the first arm's movement correspondingly moves the second arm. As the second arm's traveling end moves towards the first arm's pivotal end, the scissors mechanism moves from the contracted position to the extended position. In one embodiment, for example, the scissors mechanism may include four arms. In this embodiment, two arms have pivotal ends and two arms have traveling ends. By adding more arms, heavier objects can be lifted evenly and effectively. In addition, the arm length may vary, which could increase the maximum lifting height.

The wedging device causes a lifting action as the scissors mechanism begins moving between a contracted position and an expanded position. This wedging device can include a cam surface mounted to the first arm, connected rollers, a ramp positioned proximate the cam surface, and a carriage connected to the rollers. The cam surface could be any type of vertical lifting surface such as a block shaped surface, a hexagonal surface, a triangular surface, or a diamond shaped surface. Alternatively, the arm could include a lifting surface instead of the lifting surface being mounted to the arm. For example, a lower portion of the first arm could be shaped into a cam surface. In another alternative embodiment, first arm could include a roller and a lifting surface could be attached to the carriage instead of the rollers.

As the carriage moves, a smaller roller travels along the cam surface and a larger roller travels along the ramp. These rollers could be polyurethane wheels with ball bearings, plastic rollers, or some other suitable type of transport structure. Because the larger roller travels along the ramp, the smaller roller does not impede movement of the larger roller. The rollers rotate about the same axis but in opposite directions. For example, the first roller can rotate counter clockwise as it travels along the cam surface. In contrast, the second roller can rotate clockwise as it travels along the ramp. Since these rollers are connected, the first roller rises as the second roller goes up the ramp, which lifts the cam surface.

As the rollers contact the cam surface and ramp, the first arm pivots upward. In response, the second arm moves upward. In an alternative embodiment, the wedging device may not include a ramp and use a single roller that contacts the cam surface. In another embodiment, the wedging device can include several ramps. Alternatively, the wedging device can include ramps with various angles of incline. These ramps could be composed of aluminum, plastic, composite material, or some other suitable material. In addition, the wedging device can include several cam surfaces and several rollers. For example, a lifting device with two pivoting ends can include cam surfaces for each pivoting end. In another alternative embodiment, the carriage can connect to the cam surface, rollers, or the ramp. Even still, the carriage can attach to an underside of the table. Using this configuration, the lifting device can raise objects placed in the base by contracting the scissors mechanism.

After the lifting action, the lever device causes translational movement as the scissors mechanism continues moving between a contracted position and an expanded position. This lever device includes a rod connected between the second arm's traveling end and the carriage, a bracket connected to the carriage, and a link. These components can be formed from aluminum, plastic, a composite, or some other suitable material. Alternatively, the rod could be a bar, tube, or some other suitable shape. In an alternative embodiment, the lever device can include several rods that connect to the traveling ends. The link can slide within a slot in the bracket. As the link reaches the end of the slot, the link's continual movement translationally moves the carriage. But the carriage's movement moves the rod, which displaces the second arm's traveling end. In response, the second arm moves the first arm and the traveling end approaches the first arm's pivoting end. This moves the lifting device towards an expanded position.

Finally, an actuator initiates the lifting device's movement between a contracted positioned and an expanded position by moving substantially perpendicular to the scissors mechanism's movement. The actuator could be a hydraulic actuator, pneumatic actuator, belt-pulley based actuator, a chain-sprocket based actuator, a scissors based actuator, or any other suitable linear actuator. In one embodiment, the actuator includes switches, a motor, a nut connected to the link, and a ball screw connected between the motor and the nut. These components can be formed from high carbon steel or some other suitable material. The motor could be any one of several types of motors, such as a battery-powered electric drill motor. If the motor has a rechargeable battery, the lifting device can include a plug that connects this device to an electrical outlet and charges the battery. Alternatively, the motor can include a removable rechargeable battery that can use a recharger separate from the lifting device.

Generally, a user moves the lifting device by pressing a power switch. As the user holds the switch, the motor activates and begins spinning the ball screw in a counter clockwise direction during the expansion motion of the lifting device. Typically, this spinning direction corresponds to moving the lift from a contracted, or lowered, position to an expanded, or raised, position. In an alternative embodiment, the motor can spin the ball screw in a clockwise direction. The nut is connected to the ball screw. Thus, spinning of the ball screw translationally moves the nut along the screw, which slides the link and moves the carriage. As the rollers on the carriage move, they initiate the wedging action that begins moving the lifting device towards an expanded position. This wedging action causes the lever action, which further moves the lifting device. When the lifting device is fully raised, a user releases the power switch. Subsequently, pressing the power switch spins the ball screw in a clockwise direction and reverses the previous movements. This results in lowering the lifting device.

To support the lifting device, it can include a base with several transport structures, such as wheels, rollers, or a conveyor device. For example, the base could be a dolly with rollers. In addition, a sensor device within the base can disable the motor when an object applies pressure to the base. The motor can also mount to the base. Alternatively, the base can include a limit switches that restricts how far the table extends during the expansion motion. Various modifications can be made to the previously described lifting device. In one embodiment, the lifting device may include a steering mechanism such as a wheel, bar, motorized crank, or some other suitable steering mechanism. In another alternative embodiment, the lifting device can include powered rollers along with a steering mechanism. In addition, the lifting device can include a braking mechanism such as a foot operated wheel lock that slows the lifting speed. Alternatively, the lifting device could be remotely operated using a wireless technology such as Blue Tooth technology.

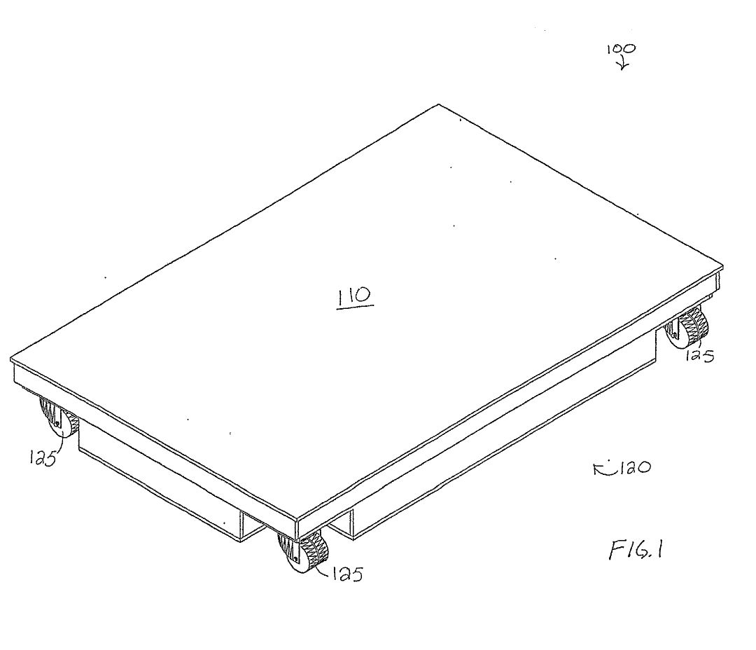

Turning now to the figures, FIG. 1 is a perspective view of a scissors lifting device 100 in a fully contracted, or lowered, position. The lifting device 100 includes a table 110, a base 120, and lifting components described with reference to subsequent figures. These lifting components are described in greater detail with reference to subsequent figures. As illustrated FIG. 1, the lifting device 100 remains completely flat when in the contracted position. The base 120 supports the lifting device 100. This base may include one or more transport structures such as transport structures 125. Because of these transport structures, the lifting device 100 is movable.

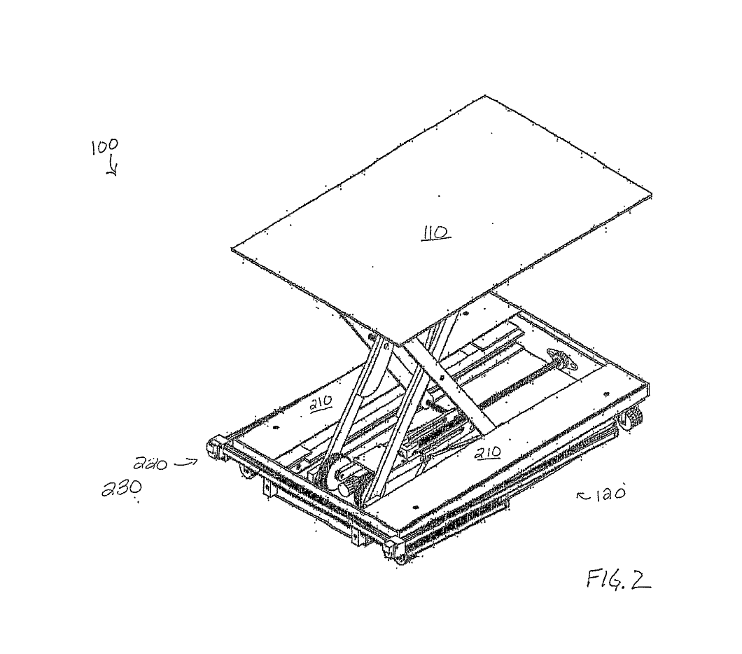

FIG. 2 is a perspective view of the scissors lifting device 100 in a fully expanded position. The lifting device 100 can also include safety devices with safety plates 210 connected to the base 120. In an alternative embodiment, these plates can be mounted to the table 110, transport structures 125, or some other components. The safety plates 210 have a substantially flat upper surface that is adjacent to and underside of the table when the lifting device 100 is in a lower position. An object lodged between the safety plates and the lifting components can exert downward pressure on the safety plates 210 that removes power from the actuator. This feature limits accidents resulting from lodging foreign objects between the safety plates 210 and the table 110. In an alternative embodiment, the lifting device 100 can include magnetic sensors, electric eyes or some other type of near field sensor instead of the safety plates 210. The lifting device 100 also includes switches 220. A user can turn on these switches by using either his foot or hand. These switches 220 could be a power switch and a directional switch. For example, a user can hold a power switch and move the lifting device to the position shown in FIG. 2. In contrast, a user can press the directional switch and subsequently press the power switch. This can lower the lifting device 100 to the position described with reference to FIG. 1. A user can guide, or position, the lifting device 100 using the handle 230. This handle can be collapsible, removable, or securely attached.

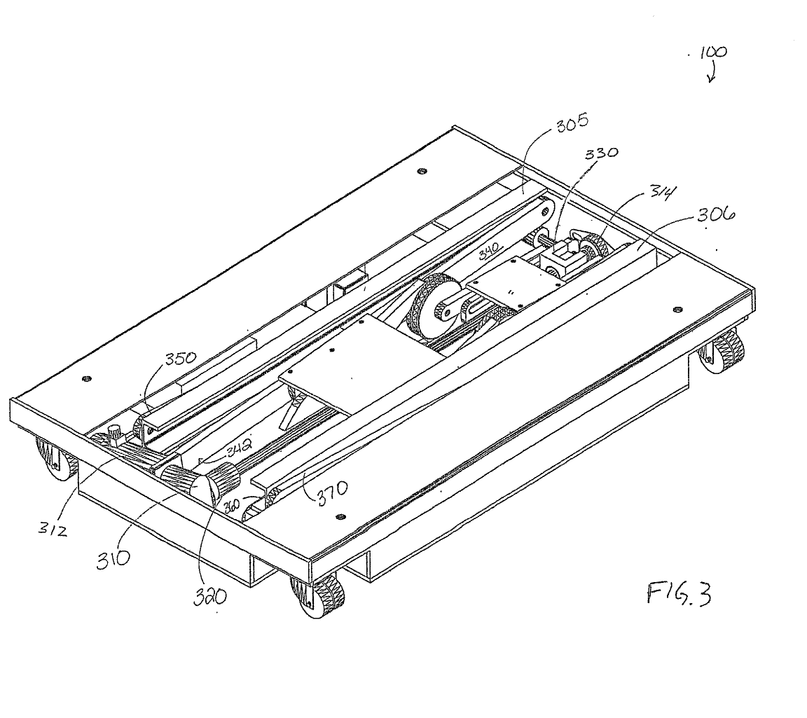

FIG. 3 is a perspective view of the scissors lifting device 100 in a fully contracted position with the upper table 110 removed to reveal some lifting components. Though not shown, openings in the channels 305, 306 can enable connecting the table 110. The lifting components include a motor 310, or gear, connected to a ball screw 320. The motor 310 can be mounted on the base 120, table 110, or some other component. To power this motor, it may include a rechargeable battery pack 312. As described above, this battery pack could be removable or include a power chord for recharging. A bearing 314 facilitates spinning of the ball screw 320. When the user presses the power switch, the motor 310 starts and spins the ball screw 320. One end of the ball screw 320 is connected to the carriage 330. The operation of this carriage is described with reference to subsequent figures.

As described above, the lifting device 100 includes a scissors mechanism. The scissors mechanism includes a first arm 340 that has a pivot end 342. The scissors mechanism includes a second arm 350 with a traveling end. For the lifting device 100, a third arm 360, which has a pivot end, and behaves similarly to the first arm 340. A fourth arm 370 also behaves similarly to the second arm 350. Thus, the lifting device 100 includes two arms 340, 360 with pivot ends and two arms 350, 370 with traveling ends. These four arms evenly lift objects positioned on the table 110.

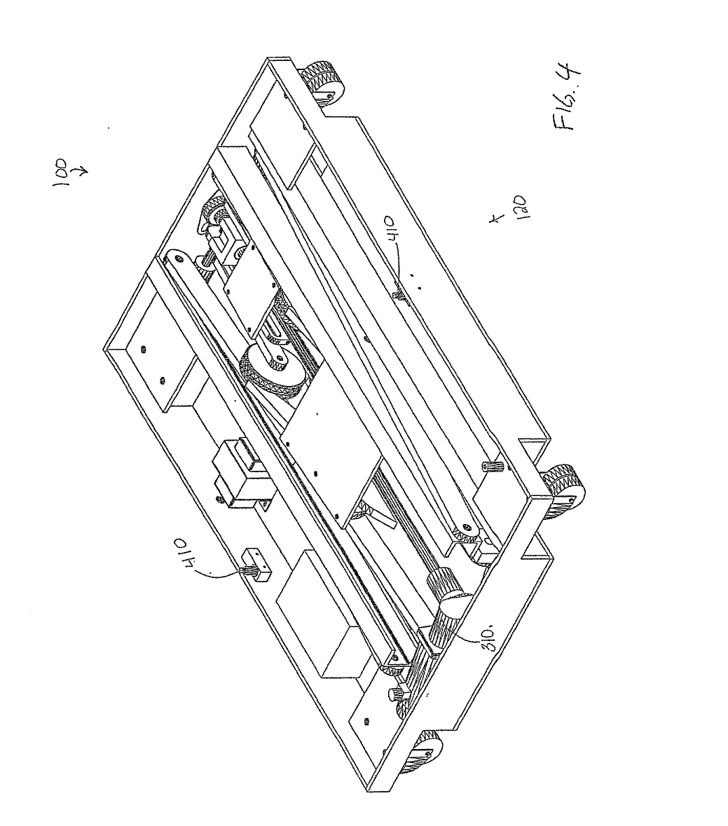

FIG. 4 is a perspective view of the scissors lifting device 100 with the safety plates 210 removed to more fully reveal additional lifting components. As previously described, applying a downward pressure to the safety plates 210 disables the motor 310. Specifically, the safety plates 210 move downward in response to this pressure and compress the switches 410. This compression of the switches actually disables the motor 310. Though this figure only shows two switches 410, the number of switches could be three, four, or some other suitable number.

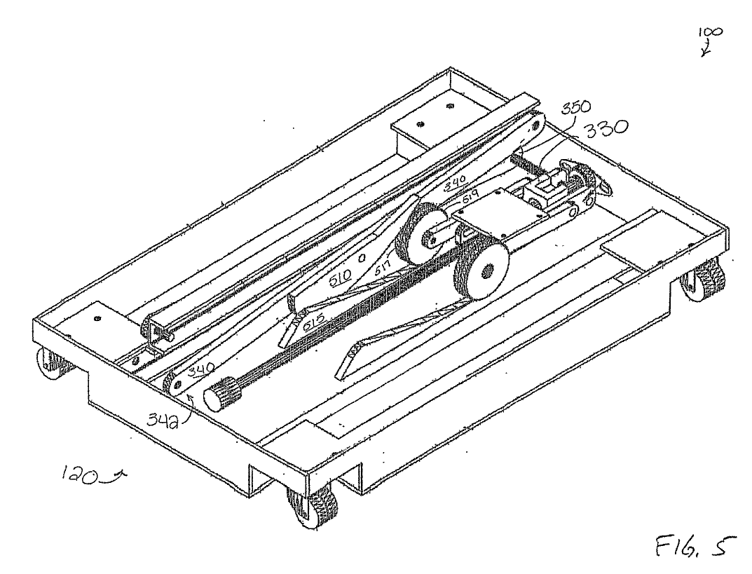

FIG. 5 is a perspective view of the scissors lifting device 100 with additional components removed to more fully reveal additional lifting components. The lifting device 100 includes a wedging device that causes a lifting action of the scissors mechanism, which initially lifts the object. The wedging device includes a cam surface 510, associated ramp 515, the carriage 330, and rollers 517, 519. The cam surface 510 connects to the arm 340. The roller 517 remains below this cam surface but suspended above the base 120 when the lifting device 100 is in the contracted position. For this position, the roller 519 rests partially on the ramp 515 and partially on the base 120. As the carriage 330 moves toward the pivot end 342, the roller 519 begins turning counter clockwise while rolling up the ramp 515. In contrast, the suspended roller 517 begins rotating clockwise as the cam surface 510 rolls along the top portion of this wheel. To provide symmetry, there may be two ramps and two lifting surfaces for two pairs of arms. Alternatively, there could be three ramps, three lifting surfaces, and three pairs of arms for more effectively lifting of heavier objects.

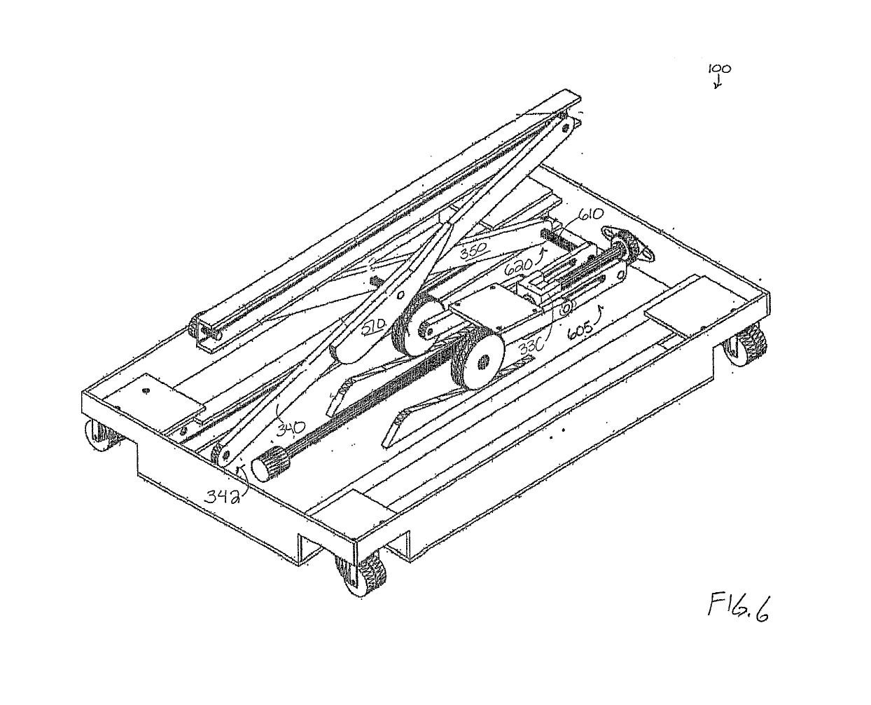

As the roller 519 continues up the ramp, the roller 517 continues rolling under the cam surface 510. Since these rollers rotate about the same axis and are connected to the carriage 330 vertically lifting the roller 519 correspondingly lifts the roller 517. In response, the cam surface 510 lifts, which pivots the arm 340 around the pivot end 342. FIG. 6 is a perspective view of the scissors lifting device 100 after a first portion of motion from the contracted position towards the expanded position. In this figure, the arm 340 has rotated approximately ten degrees from the previous figure. A sequential link 605 connects the carriage 330 to a rod 610. The rod 610 connects the link 605 to the traveling end 620. Thus, the carriage's movement towards the pivot end 342 displaces the link 605 and moves the traveling end 620 towards the pivot end 342.

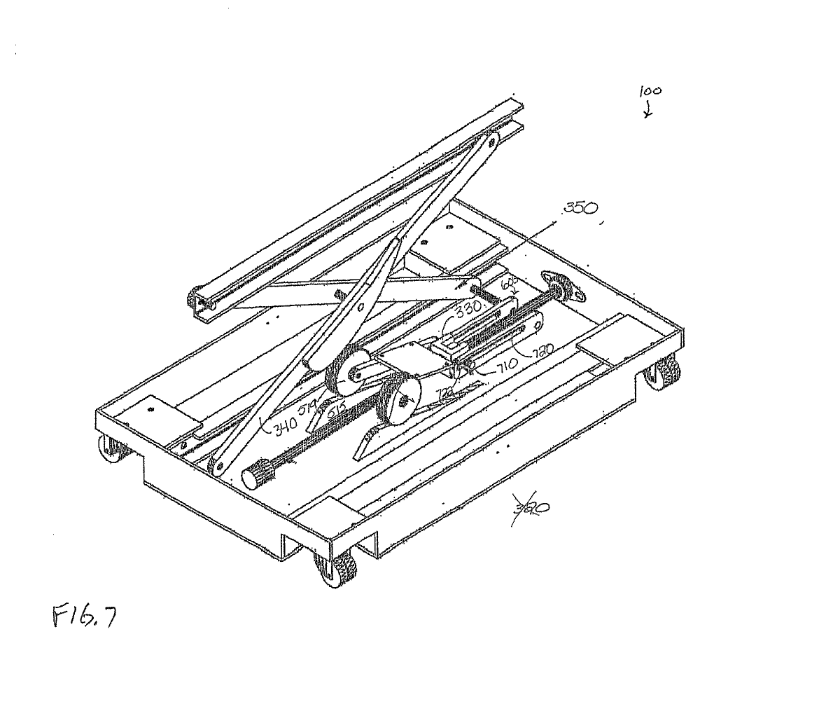

FIG. 7 is a perspective view of the scissors lifting device 100 after a second portion of motion from the contracted position towards the expanded position. In this figure, the arm 340 has rotated approximately twenty degrees from the original position. As previously described, the motor 310 spins the ball screw 320 within the carriage 330. In response, a ball nut travels along this ball screw. Because a link 710 is connected to the ball nut within the carriage 330, this link slides within a bracket slot 720 of the link 605 as the ball screw moves. In addition, the link 710 connects to the roller 519. Thus, the ball nut's movement moves the roller 519 by moving the link 720.

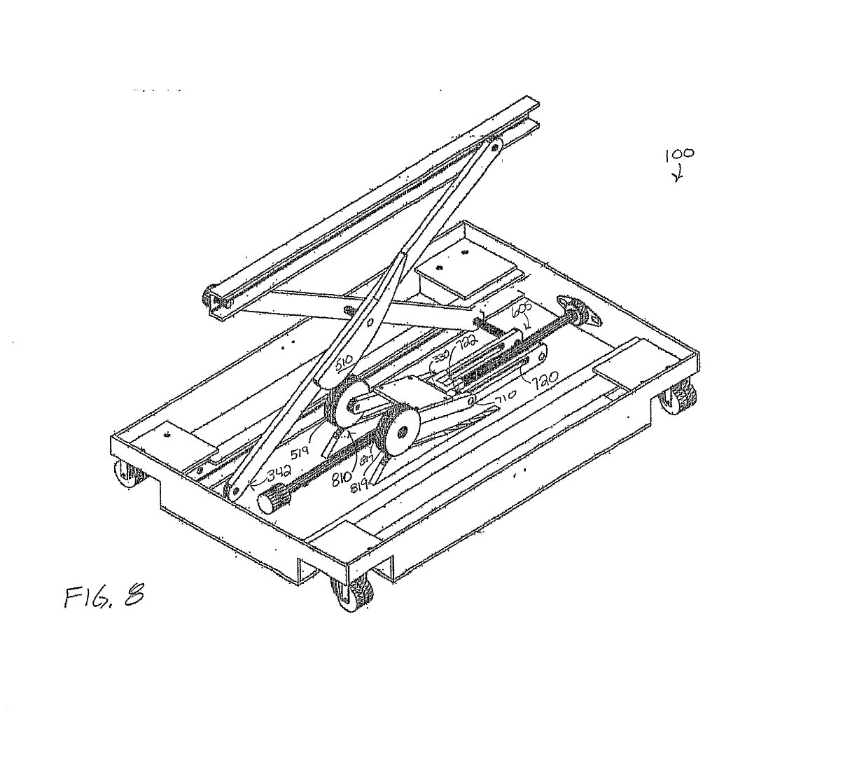

As the roller 519 approaches the peak of the ramp 515, the link 710 approaches the slot's end 722 of the sequential link 605. FIG. 8 is a perspective view of the scissors lifting device 100 after a third portion of motion from the contracted position towards the expanded position. In this figure, the arm 340 has rotated approximately twenty-five degrees from its initial position. This figure illustrates the roller 519 at the peak 810 of the ramp 515. In response, the link 710 contacts the slot's end 722 of the sequential link 605. The carriage's continual movement spins the roller 519 and drags the traveling end 620 towards the pivot end 342. For the purpose of clarity, the rollers 817, 819 are not described because they function identically to the rollers 517, 519.

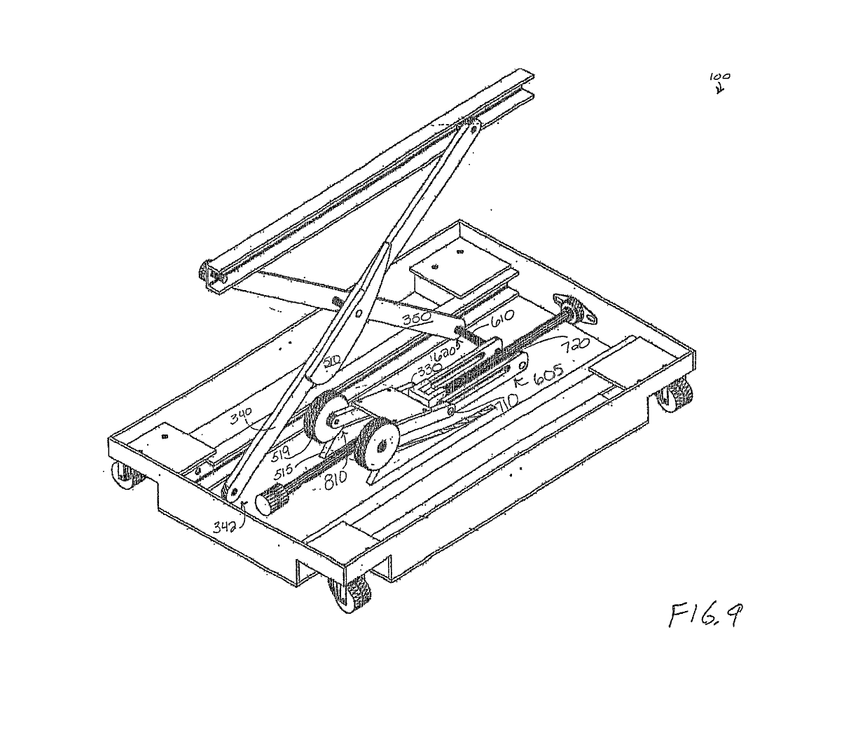

FIG. 9 is a perspective view of the scissors lifting device 100 after a fourth portion of motion from the contracted position towards the expanded position. In this figure, the arm 340 has rotated approximately thirty degrees from its initial position. Thus, the roller 519 has passed the peak 810 of the ramp 515 and has begun descending on the other side. The carriage's movement drags the traveling end 620 because the link 710 is flush against the slot's end within the sequential link 605. In response, the rod 610 moves the traveling end 620 of the arm 350 towards the pivot end 342, which further pivots the arm 340. Thus, the cam surface 510 no longer touches the roller 519. The sequential link with bracket slot 720 and link 710 along with rod 610 and carriage 133 form the lever device. This lever device lifts the table 110 when the roller 519 no longer contacts the cam surfaces. That is, the wedging device lifts the table initially and the lever device subsequently lifts the table as it moves from a contracted position to an expanded position.

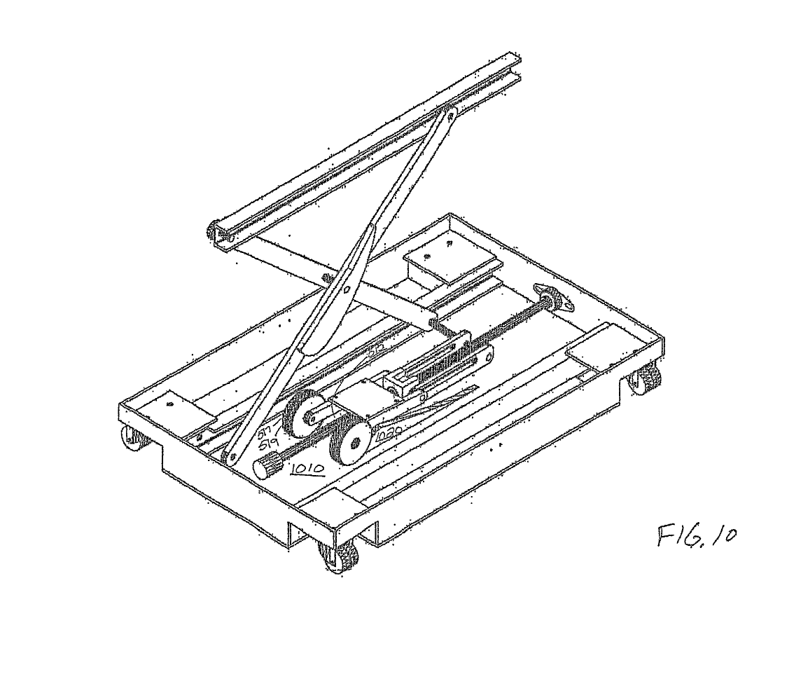

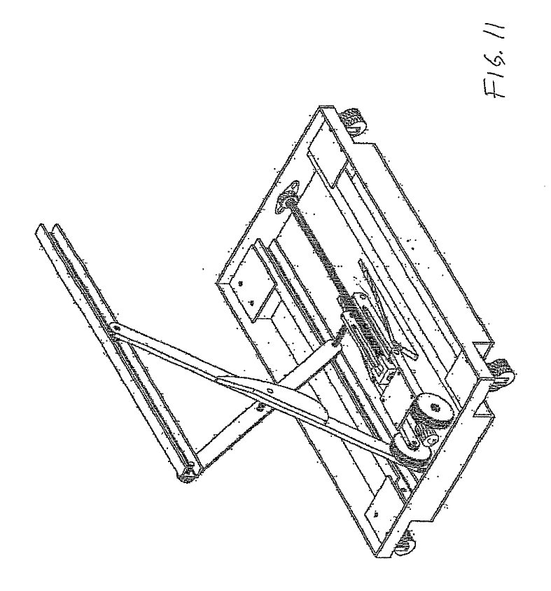

FIG. 10 is a perspective view of the scissors lifting device 100 after a fifth portion of motion from the contracted position towards the expanded position. In this figure, the arm 340 has rotated approximately thirty-five degrees from its initial position. The roller 519 contacts the base's bottom 1010 after descending on the other side of the ramp 515. The ramp 515 is identical to the ramp 1020 and is not described. As described with reference to FIG. 9, the movement of the carriage 133 towards the pivot end 342 continues expanding the lifting device 100. FIG. 11 is a perspective view of the scissors lifting device 100 in the fully expanded position. Though not shown, the lifting device 100 can include an auxiliary locking mechanism that hinders this device from unintentional collapse. For example, the locking mechanism can secure the lifting device in the expanded position shown in FIG. 11.

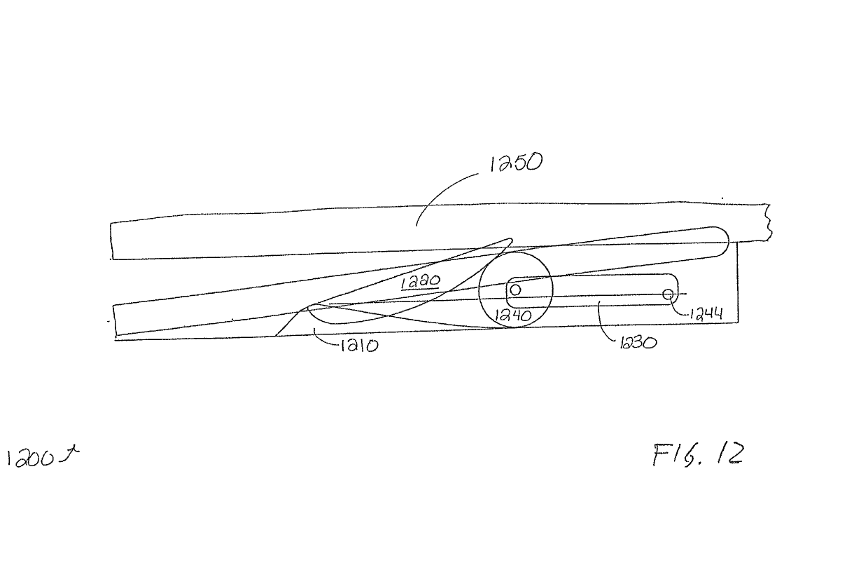

FIG. 12 is a side view of a wedging device 1200 and other lifting components for a scissors lift in a fully contracted position. This wedging device includes a ramp 1210, cam surface 1220, housing 1230, and a roller 1240 pivotally mounted to the housing 1230. When the scissors lift is in a contracted position, the roller 1240 touches the bottom of the ramp 1210. A hole 1244 in the housing 1240 connects the wedging device to a ball nut in the actuator. As the ball nut moves towards the left, the housing 1230 transfers this movement to the roller 1240 by pushing this roller. The roller 1240 pushes the cam surface 1220 upward, which in turn lifts the table 1250. Hence, the wedging device 1200 initially moves the scissors lift from a contracted position towards an expanded position.

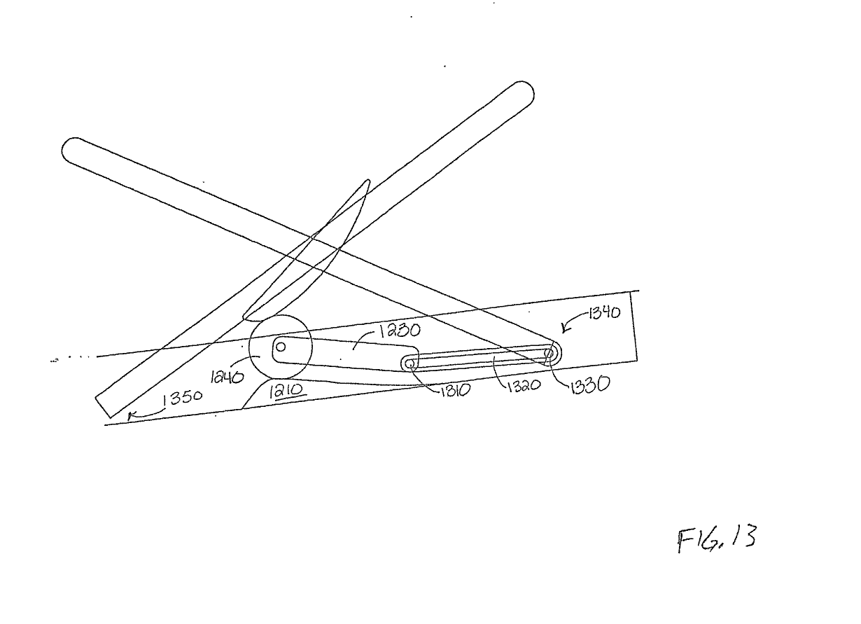

FIG. 13 is a side view of the wedging device 1200 and other lifting components for a scissors lift after operation of the wedging device 1200 imparts a lifting action on the scissors lift. A link 1310 connects the actuator's ball screw to the housing 1230. The link 1310 slides within the bracket slot 1320. The rod 1310 reaches the end of the slot 1320 as the roller 1240 reaches the top of the ramp 1210. In contrast, the rod 1330 is fixedly attached to the traveling end 1340. Thus, additional movement of the roller 1240 pulls the link 1310, which drags the traveling end 1340 towards the pivot end 1350. A carriage, not shown, houses the link 1310.

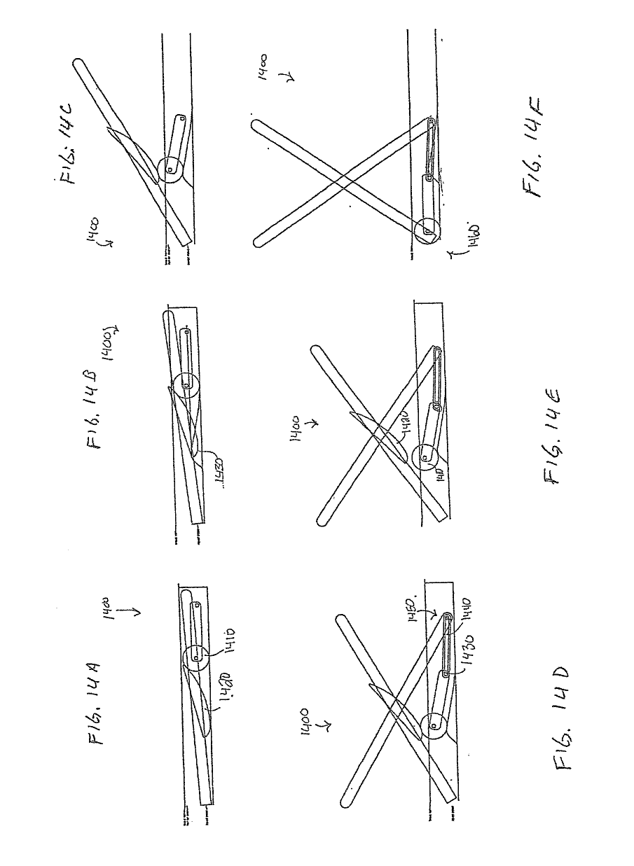

FIGS. 14A-F are a series of side views of a combination wedging and lever device for a scissors lift 1400 progressively showing the expansion of the lift from a fully contracted position to a fully expanded position. In FIG. 14A, the roller 1410 barely touches the cam surface 1420. From this starting position, the actuator's operation can slightly move the roller to the beginning of the ramp 1430 as illustrated in FIG. 14B. After rotating approximately thirty degrees from the original position, the roller 1410 reaches the position shown in FIG. 14C. Before this position, the roller's continual movement and contact with the cam surface 1420 raised the scissors lift 1400, which represents the lifting action completed by the wedging device. At the position depicted in FIG. 14C, the roller 1410 is at the ramp's peak and the wedging action is ending.

This is more clearly seen in FIG. 14D where a link 1430 on a carriage contacts an edge of the slot 1440. Because the arm's traveling end 1450 is also attached to the carriage, additional movement of the roller 1410 beyond this position translationally moves the traveling end 1450. As previously mentioned, the arms 1453, 1455 are connected. Thus, moving the traveling end 1450 moves these arms and raises the scissors lift 1400. FIG. 14E illustrates the arms' movement and the roller's movement that moves the cam surface 1420 away from the roller 1410. As this roller continues moving, it reaches an end 1460 that stops additional movement.

One skilled in the art will appreciate that the series of motions illustrated in FIGS. 14A-F for the expansion motion are equally applicable to the contraction motion. That is, the scissors lift completes the same motions in a reverse order as it moves from an expanded position to a contracted position. For a contraction motion, the lever device initially begins contracting the lift. As previously described, the actuator spins the ball screw in an opposite direction for the contraction motion. Gravity acts on the scissors lift and maintains the link 1430 in the position within the slot 1440 shown in FIG. 14E. Thus, the roller moves the carriage back to a starting position before the link 1430 begins sliding within the carriage and the wedging action takes over. Ultimately, the roller 1410 returns to the position shown in FIG. 14A.

It should be understood that the foregoing relates only to the exemplary embodiments of the present invention, and that numerous changes may be made therein without departing from the spirit and scope of the invention as defined by the following claims.

The invention claimed is:

1. A lifting device, comprising:
a scissors mechanism having a first arm with a pivotally mounted end and a second arm with a traveling end, the scissors mechanism being movable from a contracted position to an expanded position as the traveling end moves toward the pivotally mounted end, and being movable from the expanded position to the contracted position as the traveling end moves away from the pivotally mounted end;
a wedging device configured to move the scissors mechanism through lifting action applied during an initial portion of the motion of the scissors mechanism from the contracted position to the expanded position; and
a lever device configured to move the scissors mechanism through translation action applied to the traveling end of the second arm during continued movement of the scissors mechanism from the contracted position to the expanded position.

2. The lifting device of claim 1, wherein:
the lever device is configured to move the scissors mechanism through translation action applied to the traveling end of the second arm during an initial portion of the movement of the scissors mechanism from the expanded position to the contracted position; and
the wedging device is configured to move the scissors mechanism during continued movement of the scissors mechanism from the expanded position to the contracted position.

3. The lifting device of claim 2, further comprising:
an actuator movable from a first position to a second position; and
a linkage configured to couple the movement of the actuator to the wedging device during an initial portion of the movement of the actuator from the first position to the second position, and configured to couple the movement of the actuator to the lever device during continued movement of the actuator from the first position to the second position.

4. The lifting device of claim 3, wherein the linkage is further configured to couple the movement of the actuator to the lever device during an initial portion of the movement of the actuator from the second position to the first position, and configured to couple the movement of the actuator to the wedging device during continued movement of the actuator from the second position to the first position.

5. The lifting device of claim 4, wherein the motion of the actuator between the first position and the second is substantially perpendicular to the movement of the scissors mechanism between the contracted position to the expanded position.

6. The lifting device of claim 3, wherein the wedging device comprises:
a cam surface;
a first roller configured to travel along the cam surface;
a second roller configured to travel along a lifting surface;
a movable carriage coupled to the actuator;
the movable carriage also coupled to the cam surface, the first roller, or the second roller;
whereby the wedging device imparts the lifting action on the scissors mechanism as the first roller travels along the cam surface and the second roller travels along the lifting surface under the force of the actuator coupled through the movable carriage.

7. The lifting device of claim 6, wherein the linkage comprises:
a link coupled to the movable carriage; and
the link is slidably constrained within a slot in a bracket that is coupled to the traveling end of the second arm of the scissors mechanism.

8. The lifting device of claim 7, further comprising:
a base configured to support the scissors mechanism; and
a table supported by the scissors mechanism and configured to remain substantially parallel to the base as the scissors mechanism moves between the contracted position to the expanded position.

9. The lifting device of claim 8, further comprising a safety device configured to discontinue operation of the actuator in response to detecting pressure applied to the base by a structure other than the scissors mechanism.

10. The lifting device of claim 8, wherein the base further comprises a dolly.

11. The lifting device of claim 7, wherein:
the actuator comprises a ball screw and a motor operable to spin the ball screw; and
the link comprises a ball nut captured on the ball screw and operable to travel along the ball screw in response to spinning of the ball screw.

12. The lifting device of claim 1, wherein the lifting action is applied to a cam surface connected to the first arm of the scissors mechanism.

13. The lifting device of claim 1, further comprising a base supporting the scissors mechanism and a first cam surface connected to the first arm of the scissors mechanism, and wherein the wedging mechanism comprises:
a second cam surface connected to the base;
a first roller configured to travel along the first cam surface;
a second roller configured to travel along the second cam surface;
a movable carriage coupled to the actuator;
the movable carriage also coupled to the cam surface, the first roller, or the second roller; and
whereby the wedging device imparts the lifting action on the scissors mechanism as the first roller travels along the first cam surface and the second roller travels along the second cam surface under the force of the actuator coupled through the movable carriage.

14. The lifting device of claim 13, further comprising:
an actuator movable from a first position to a second position; and
a linkage configured to couple the movement of the actuator to the wedging device during an initial portion of the movement of the actuator from the first position to the second position, and configured to couple the movement of the actuator to the lever device during continued movement of the actuator from the first position to the second position.

15. The lifting device of claim 14, wherein the linkage comprises:
a link coupled to the movable carriage; and
the link is slidably constrained within a slot in a bracket that is coupled to the traveling end of the second arm of the scissors mechanism.

16. A lifting device, comprising:
a scissors mechanism having a first arm with a pivotally mounted end and a second arm with a traveling end;
the scissors mechanism being movable from a contracted position to an expanded position as the traveling end moves toward the pivotally mounted end, and being movable from the expanded position to the contracted position as the traveling end moves away from the pivotally mounted end;
a wedging device configured to move the scissors mechanism through lifting action applied during an initial portion of the motion of the scissors mechanism from the contracted position to the expanded position;
a lever device configured to move the scissors mechanism through translation action applied to the traveling end of the second arm during continued movement of the scissors mechanism from the contracted position to the expanded position;
an actuator movable from a first position to a second position; and
a linkage configured to couple the movement of the actuator to the wedging device during an initial portion of the movement of the actuator from the first position to the second position, and configured to couple the movement of the actuator to the lever device during continued movement of the actuator from the first position to the second position.

17. The lifting device of claim 3, wherein:
the lever device is further configured to move the scissors mechanism through translation action applied to the traveling end of the second arm during an initial portion of the movement of the scissors mechanism from the expanded position to the contracted position;
the wedging device is further configured to move the scissors mechanism during continued movement of the scissors mechanism from the expanded position to the contracted position; and
the linkage is further configured to couple the movement of the actuator to the lever device during an initial portion of the movement of the actuator from the second position to the first position, and configured to couple the movement of the actuator to the wedging device during continued movement of the actuator from the second position to the first position.

18. The lifting device of claim 17, wherein the motion of the linear actuator between the first position and the second is substantially perpendicular to the movement of the scissors mechanism between the contracted position to the expanded position.

19. The lifting device of claim 18, wherein the wedging device comprises:
a cam surface;
a first roller configured to travel along the cam surface;
a second roller configured to travel along a lifting surface;
a movable carriage coupled to the actuator;
the movable carriage also coupled to the cam surface, the first roller, or the second roller;
whereby the wedging device imparts the lifting action on the scissors mechanism as the first roller travels along the cam surface and the second roller travels along the lifting surface under the force of the actuator coupled through the movable carriage.

20. The lifting device of claim 19, further comprising:
a base configured to support the scissors mechanism; and
a table supported by the scissors mechanism and configured to remain substantially parallel to the base as the scissors mechanism moves between the contracted position to the expanded position.

21. The lifting device of claim 20, further comprising a safety device configured to discontinue operation of the actuator in response to detecting pressure applied to the base by a structure other than the scissors mechanism.

22. The lifting device of claim 20, wherein the base further comprises a dolly.

23 The lifting device of claim 20, wherein:
the actuator comprises a ball screw and a motor operable to spin the ball screw; and
the link comprises a ball nut captured on the ball screw and operable to travel along the ball screw in response to spinning of the ball screw.

24 A lifting device, comprising:
a scissors mechanism having a first arm with a pivotally mounted end and a second arm with a traveling end;
the scissors mechanism being movable from a contracted position to an expanded position as the traveling end moves toward the pivotally mounted end, and being movable from the expanded position to the contracted position as the traveling end moves away from the pivotally mounted end;
a wedging device configured to move the scissors mechanism through lifting action applied to a lifting surface during an initial portion of the motion of the scissors mechanism from the contracted position to the expanded position;
wedging device comprising:
a cam surface,
a first roller configured to travel along the cam surface,
a second roller configured to travel along the lifting surface,
a movable carriage coupled to the actuator, the movable carriage also coupled to the cam surface, the first roller, or the second roller, and
whereby the wedging device imparts the lifting action on the scissors mechanism as the first roller travels along the cam surface and the second roller travels along the lifting surface under the force of the actuator coupled through the movable carriage;
a lever device configured to move the scissors mechanism through translation action applied to the traveling end of the second arm during continued movement of the scissors mechanism from the contracted position to the expanded position;
the lever device further configured to move the scissors mechanism through translation action applied to the traveling end of the second arm during an initial portion of the movement of the scissors mechanism from the expanded position to the contracted position;
the wedging device further configured to move the scissors mechanism during continued movement of the scissors mechanism from the expanded position to the contracted position; and
an actuator movable from a first position to a second position;
a linkage configured to couple the movement of the actuator to the wedging device during an initial portion of the movement of the actuator from the first position to the second position, and configured to couple the movement of the actuator to the lever device during continued movement of the actuator from the first position to the second position;
the linkage further configured to couple the movement of the actuator to the lever device during an initial portion of the movement of the actuator from the second position to the first position, and configured to couple the movement of the actuator to the wedging device during continued movement of the actuator from the second position to the first position; and
wherein the motion of the linear actuator between the first position and the second is substantially perpendicular to the movement of the scissors mechanism between the contracted position to the expanded position.

25. The lifting device of claim 24, further comprising:
a base configured to support the scissors mechanism; and
a table supported by the scissors mechanism and configured to remain substantially parallel to the base as the scissors mechanism moves between the contracted position to the expanded position.

26. The lifting device of claim 25, further comprising a safety device configured to discontinue operation of the actuator in response to detecting pressure applied to the base by a structure other than the scissors mechanism.

27. The lifting device of claim 26, wherein the base further comprises a dolly.

28. The lifting device of claim 24, wherein the linkage comprises:
a link coupled to the movable carriage; and
the link is slidably constrained within a slot in a bracket that is coupled to the traveling end of the second arm of the scissors mechanism.

29. The lifting device of claim 28, wherein:
the actuator comprises a ball screw and a motor operable to spin the ball screw; and
the link comprises a ball nut captured on the ball screw and operable to travel along the ball screw in response to spinning of the ball screw.

30. The lifting device of claim 28, wherein the lifting action is applied to a cam surface connected to the first arm of the scissors mechanism.

31. A lifting device comprising a scissors mechanism movable from a contracted position to an expanded position, wherein the improvement comprises:
a wedging device configured to move the scissors mechanism through lifting action applied during an initial portion of the motion of the scissors mechanism from the contracted position to the expanded position.
